(19) United States
(12) Patent Application Publication
(10) Pub. No.: US 2007/0024600 A1
(43) Pub. Date: Feb. 1, 2007

(54) Pen-type optical mouse

(76) Inventors: Kuo-Wen Chang, Hsinchu (TW); Ming-Sen Tsao, Hsinchu (TW)

Correspondence Address: LIN & ASSOCIATES INTELLECTUAL PROPERTY, P.O. BOX 2339, SARATOGA, CA, 95070-0339, US

(21) Appl. No.: 11/189,264

(22) Filed: Jul. 26, 2005

(51) Int. Cl. G09G 5/00

(52) U.S. Cl. 345/179

(57) ABSTRACT

A pen-type optical mouse includes a pen-type mouse main body, a first and second printed circuit boards disposed on two sides of the interior of the main body and in a direction parallel to the central axis of the main body respectively, a light emitting element mounted on the printed circuit board, a sensor die mounted on the other side of the printed circuit board opposite to the side on which the light emitting element is mounted, and an imaging system for guiding light emitted from the light emitting element to be irradiated onto and reflected by a work surface and then guiding the reflected light so as to be imaged and incident on the sensor die. As the light emitting element and the sensor die are arranged on opposite sides of the same printed circuit board, light emitted from the light emitting element is prevented from being directly incident on the sensor die so as not to reduce the contrast of images.

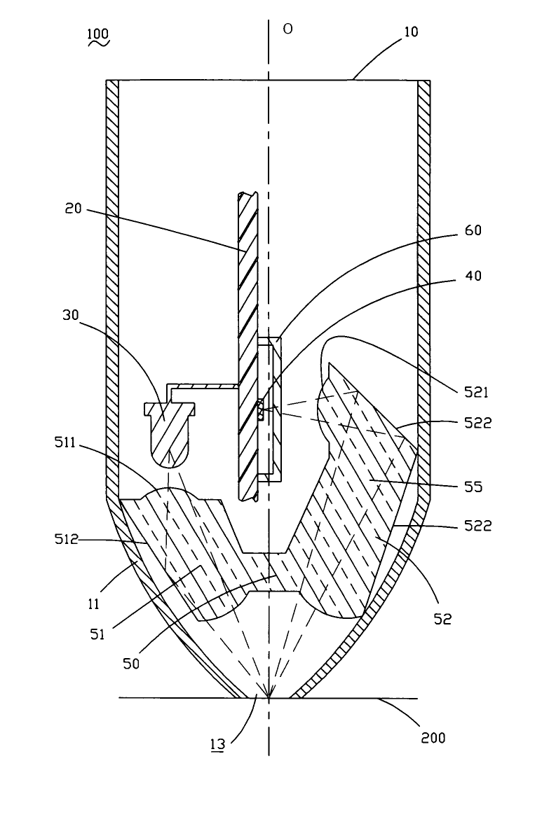

### BACKGROUND OF THE INVENTION

1. Field of the Invention

The present invention relates to an optical mouse, and more particularly, to a pen-type optical mouse in which light emitted from a light emitting element is prevented from being directly incident on a sensor die, thus ensuring the performance of the pen-type optical mouse by not reducing the contrast of images.

2. The Related Art

A mouse, which is one of the input means for computers, is a device that is used to directly or indirectly instruct a computer on the coordinates of a cursor displayed on a monitor of a computer. Such mice are classified into two types; ball mice that each inputs the moving direction and distance of the mouse by utilizing the rotation of a ball, and optical mice that each detects the moving direction and distance of the mouse by tracing the movement of the images of a work surface formed by light emitted from the mouse body.

As need not to be periodically cleaned and have other well-known advantages, optical mice become more and more popular. In order to perform natural writing and drawing operation with the optical mice, pen-type optical mice have been developed.

A conventional pen-type optical mouse includes a cylindrical body, an illumination source, a lens, and an optical motion sensor. The illumination source emits light, and the lens allows reflected light, which is generated when the light emitted from the illumination source is reflected off a work surface, to be imaged. Then, when a series of images of the work surface imaged through the lens are captured with the optical motion sensor, a direction and amount of movement of the mouse are obtained from variations in the images due to motion of the mouse. However, in order to image the reflected light from the work surface and capture the image, the lens and the optical motion sensor are arranged facing to the work surface, that is, are arranged in a direction perpendicular to a central axis of the body. The dimension of the optical motion sensor in the direction perpendicular to the central axis of the body is relatively longer than that in a direction parallel to the central axis. Therefore, the arrangement of the optical motion sensor in such manner results in enlargement of the diameter of the mouse. It is difficult to use the mouse while holding in one's hand.

Another conventional pen-type optical mouse is described in Pub. No. US 2003/0112220 by Yang et al., published on Jun. 19, 2003. The conventional pen-type optical mouse includes a pen-type mouse main body, an illumination unit, an imaging system, an image sensor and a control means. The imaging system is capable of changing a path of the reflected light in addition to imaging light so that the reflected light can be received by the image sensor. So the image sensor and the control means are permitted to be disposed on a side of the interior of the main body parallel to a central axis of the main body to overcome the above-mentioned problem. However, the illumination unit and the image sensor are arranged adjacent to each other, and have no structure or means blocked therebetween. Thus, some light emitted from the illumination unit is inevitably and directly incident on the image sensor, which reduces the contrast of images and, in turn, affects the performance of the pen-type optical mouse. In addition, the imaging system comprises individual lens, prism and light guide. The number of component parts is large so that the assembly work is troublesome and the manufacturing costs of the optical mouse are increased.

In view of the above, an improved pen-type optical mouse that overcomes the above-mentioned problems is strongly desired.

### SUMMARY OF THE INVENTION

An object of the present invention is to provide pen-type optical mouse in which light emitted from a light emitting element is prevented from being directly incident on a sensor die, thus ensuring the performance of the pen-type optical mouse.

In order to accomplish the above object, the present invention provides a pen-type optical mouse for enabling the position of the cursor to be displayed on a monitor of a computer by detecting its own movement using reflected light, comprising:
a pen-type mouse main body having a central axis and a pen head at a lower end of the main body, an opening being defined in bottom of the pen head;
a printed circuit board installed in the main body, the printed circuit board being disposed in a direction parallel to the central axis of the main body;
a light emitting element mounted on one side of the printed circuit board for emitting light;
a sensor die mounted on the other side of the printed circuit board opposite to the side on which the light emitting element is mounted, the sensor die comprising an image sensor and an image processing unit; and
an imaging system for guiding light emitted from the light emitting element to pass through the opening and then be irradiated onto and reflected by a work surface, and for guiding the reflected light so as to be imaged and then be incident on the image sensor, the image sensor sensing the light incident thereon and converting the light into electrical signals to be transmitted to the image processing unit, the image processing unit calculating coordinate values of the cursor displayed on the monitor based on the converted electrical signals from the image sensor.

As the light emitting element and the sensor die are arranged on opposite sides of the same printed circuit board, light emitted from the light emitting element is prevented by the printed circuit board from being directly incident on the sensor die. Thus the contrast of the images is not reduced, and performance of the pen-type optical mouse is ensured.

Preferably, the imaging system is a prism-integrated lens serving as a light guide and imaging images, which allows the number of component parts to be reduced, thus facilitating assembling of the optical mouse and curtailing the manufacturing costs of the optical mouse.

Other objects, advantages and novel features of the invention will become more apparent from the following detailed description of a preferred embodiment thereof when taken in conjunction with the accompanying drawing, wherein:

### BRIEF DESCRIPTION OF THE DRAWING

The FIGURE is a cross-sectional view of a pen-type optical mouse in accordance with the present invention.

### DETAILED DESCRIPTION OF THE PREFERRED EMBODIMENT

Referring to the FIGURE, a pen-type optical mouse 100 in accordance with the present invention includes a pen-type mouse main body 10, a printed circuit board 20, a light emitting element 30, a sensor die 40, an imaging system 55, and an aperture 60.

The main body 10 of the optical mouse 100 is shaped like a pen with a tapered pen head 11 at a lower end thereof such that a user can conveniently grasp it and perform natural writing operation. An opening 13 is defined in the bottom of the pen head 11. The main body 10 has a central axis O.

The printed circuit board 20 is installed in the main body 10, and is disposed in a direction parallel to the central axis O of the main body 10. Preferably, the printed circuit board 20 is positioned adjacent to the central axis O.

The light emitting element 30 is mechanically mounted on a left side of the printed circuit board 20 and electrically connected to the printed circuit board 20. The light emitting element 30 is activated to emit light by manual control or when the pen head 11 is sensed to come into contact with a work surface 200.

The sensor die 40 is mechanically mounted on a right side of the printed circuit board 20 opposite to the left side and electrically connected to the printed circuit board 20. In other words, the sensor die 40 and the light emitting element 30 are disposed on opposite sides of the printed circuit board 20. As a result, the sensor die 40 and the light emitting element 30 are blocked or separated from each other by the printed circuit board 20. The sensor die 40 includes an image sensor for detecting light converged by the imaging system 55 and converting the light into electrical signals and an image processing unit for processing the electrical signals.

The aperture 60 is mounted on the printed circuit board 20 and positioned on the sensor die 40 to permit the light from a predetermined scope to pass therethrough, thereby rejecting the undesired light. Concretely, the aperture 60 primarily allows the light converged by the imaging system 55 to pass therethrough to be incident on the image sensor.

The imaging system 55 includes a prism-integrated lens 50 serving as a light guide and imaging images for guiding light emitted from the light emitting element 30 to pass through the opening 13 and then be irradiated onto and reflected by the work surface 200, and for guiding the reflected light so as to be imaged and then be incident on the image sensor. The prism-integrated lens 50 is fabricated of a unitarily molded single component of transparent material, such as transparent plastic or the like. The prism-integrated lens 50 has a first portion 51 corresponding to the light emitting element 30 and a second portion 52 corresponding to the sensor die 40. The prism-integrated lens 50 is disposed between the opening 13 and the printed circuit board 20 in the main body 10 with the first and second portions lying on opposite sides of the central axis O. The first portion 51 has a first lens surface 511 facing to the light emitting element 30 for converging light emitted from the light emitting element 30 and a first reflection surface 512 inclined at an angle capable of reflecting the converged light toward the work surface 200. In brief, the first portion 51 functions to guide the light emitted from the light emitting element 30 to pass through the opening 13 and then be irradiated onto the work surface 200. The second portion 52 has a plurality of second reflection surfaces 522 and a second lens surface 521 facing to the image sensor. The second reflection surfaces 522 are inclined so that they together can reflect the light reflected from the work surface 200 toward the second lens surface 521. The second lens surface 521 allows the reflected light to be imaged. In brief, the second portion 52 acts as guiding the light reflected by the work surface 200 to be imaged and, thereafter, incident on the image sensor. Preferably, the second portion 52 of the prism-integrated lens 50 is configured capable of total internal reflection of the light reflected from the work surface 200 to prevent the light from leaking out from the second portion 52. It will be appreciated that, alternatively, the second reflection surfaces 522 each are plated with a coating on an outer side thereof to function as a mirror to prevent the light from leaking out from the second portion 52.

When the light reflected by the work surface 200 is incident on the image sensor, the image sensor senses an image of the work surface 200 and converts the image into electrical signals. Then the electrical signals are transmitted to the image processing unit. The image processing unit calculates coordinate values of the cursor displayed on the monitor based on the converted electrical signals from the image sensor. Then the coordinate values are transferred to the computer.

As described above, the sensor die 40 and the light emitting element 30 are blocked or separated from each other by the printed circuit board 20, light emitted from the light emitting element 30 is prevented by the printed circuit board 20 from being directly incident on the sensor die 40. Thus the contrast of the images is not reduced, and performance of the pen-type optical mouse is ensured.

Furthermore, The imaging system 55 is a unitarily molded single component which allows the number of component parts to be reduced, thus facilitating assembling of the optical mouse 100 and curtailing the manufacturing costs of the optical mouse 100.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to a person skilled in the art are intended to be included within the scope of this invention as defined by the accompanying claims.

What is claimed is:

1. A pen-type optical mouse for enabling the position of the cursor to be displayed on a monitor of a computer by detecting its own movement using reflected light, comprising:
a pen-type mouse main body having a central axis and a pen head at a lower end of the main body, an opening being defined in bottom of the pen head;
a printed circuit board installed in the main body, the printed circuit board being disposed in a direction parallel to the central axis of the main body;
a light emitting element mounted on one side of the printed circuit board for emitting light;
a sensor die mounted on the other side of the printed circuit board opposite to said side, the sensor die comprising an image sensor and an image processing unit; and
an imaging system for guiding light emitted from the light emitting element to pass through the opening and then be irradiated onto and reflected by a work surface, and for guiding the reflected light so as to be imaged and then be incident on the image sensor, the image sensor sensing the light incident thereon and converting the light into electrical signals to be transmitted to the image processing unit, the image processing unit calculating coordinate values of the cursor displayed on the monitor based on the converted electrical signals from the image sensor.

2. The pen-type optical mouse as claimed in claim 1, wherein the imaging system comprises a prism-integrated lens, the prism-integrated lens has a first portion with a first lens surface facing to the light emitting element for converging light emitted from the light emitting element and guiding the light to pass through the opening and be irradiated onto the work surface, the prism-integrated lens further has a second portion with a second lens surface facing to the image sensor so that the light reflected by the work surface is guided to and then imaged by the second lens surface and, thereafter, is incident on the image sensor.

3. The pen-type optical mouse as claimed in claim 2, wherein the first portion of the prism-integrated lens further has a first reflection surface inclined at an angle capable of reflecting the converged light toward the work surface.

4. The pen-type optical mouse as claimed in claim 2, wherein the second portion of the prism-integrated lens further has at least one second reflection surface inclined at an angle capable of reflecting the light reflected from the work surface toward the second lens surface.

5. The pen-type optical mouse as claimed in claim 4, wherein the second reflection surface is plated with a coating on an outer side thereof.

6. The pen-type optical mouse as claimed in claim 2, wherein the second portion of the prism-integrated lens is configured capable of total internal reflection of the light reflected from the work surface.

7. The pen-type optical mouse as claimed in claim 1, further comprising an aperture installed on the printed circuit board and located on the image sensor.
